(19) United States
(12) Patent Application Publication
(10) Pub. No.: US 2020/0033836 A1
(43) Pub. Date: Jan. 30, 2020

(54) TOOL MANAGEMENT SYSTEM, TOOL MANAGEMENT DEVICE, AND TOOL MANAGEMENT METHOD

(71) Applicant: FANUC Corporation, Yamanashi (JP)

(72) Inventor: Yasushi HAYASHI, Yamanashi (JP)

(21) Appl. No.: 16/512,380

(22) Filed: Jul. 16, 2019

(30) Foreign Application Priority Data
Jul. 26, 2018 (JP) 2018-140522

(51) Int. Cl. G05B 19/4093

(52) U.S. Cl. CPC G05B 19/40938; G05B 2219/35012; G05B 2219/50313

(57) ABSTRACT

A tool management system includes a CNC for controlling a machine tool and tool management device configured to manage information on a tool. The CNC notifies the tool management device of information on a mounted state of the tool in the machine tool. The tool management device stores tool management data in which tool type data including information common to tool types and tool object data including information on each individual tool are associated with one another. The tool object data includes the information on the mounted state of the tool.

### RELATED APPLICATIONS

The present application claims priority to Japanese Patent Application Number 2018-140522 filed Jul. 26, 2018, the disclosure of which is hereby incorporated by reference herein in its entirety.

### BACKGROUND OF THE INVENTION

### Field of the Invention

The present invention relates to a tool management system, tool management device, and tool management method, and more particularly, to a tool management system, tool management device, and tool management method for performing efficient tool management.

### Description of the Related Art

Any of a tool management device, CAM (computer-aided manufacturing device), or CNC (computer numerical controller) with a tool database is a device that deals with tool information. Conventionally, the tool information handled by these devices is not always unified, and the maintenance of integrity between the devices requires manual work.

In the CNC, for example, the tool information is managed by a tool number, tool type number, magazine number, and pot number (see FIG. 1). The correspondence of the tool and tool type numbers with the magazine and pot numbers can vary depending on each machine tool. This is because a magazine and a pot to be mounted with a tool identified by the tool number or the tool type number can be arbitrarily determined for each machine tool.

In the CAM, on the other hand, a use tool is specified by the tool number or the tool type number with reference to the tool database without dealing with the concept of magazine number or pot number. Therefore, whether or not the CNC selects as intended during machining a tool having been specified at the time of NC program creation in the CAM depends on whether or not the tool is mounted as intended in the magazine and the pot of each machine tool and the mounted state is registered as intended in the CNC.

Thus, an operator of the CNC is expected to check a manual to confirm the tool having been specified at the time of NC program creation in the CAM, mount the tool described in the manual in a pot of the machine tool, and correctly register the tool number of the mounted tool in the CNC.

Japanese Patent Application Laid-Open No. 2004-142025 discloses a method in which the identity of tools is secured to prevent a setup error by introducing a tool type, tool diameter, tool length, tool diameter compensation number, and tool length compensation number into tool attribute information managed by a CNC or entering unique tool type names in comments of an NC program.

Conventional tool management methods including the one described in Japanese Patent Application Laid-Open No. 2004-142025 have the following problems.

(1) The operator of the CNC is required to visually check the tools so that tool numbers and tool type numbers described in the NC program are in correct correspondence with the tools mounted in magazines and pots of machine tools and to mount and register the tools. This takes a lot of time and labor.

(2) The CNC manages the tool information with the tool number, tool type number, magazine number, and pot number. The correspondence between these numbers can vary depending on each machine tool. The tool indicated by the tool number and the tool type number depends on the mounted state of the tool in the magazine and the pot. Therefore, a setup error easily occurs, so that a wrong tool may possibly be used for machining. Although it is convenient if the mounted state of the tool and the like can be made common to all the machine tools, the operation thereof would take a lot of time and labor.

(3) The CNC manages a tool offset amount using a data table separate from a table that defines the correspondence between the tool number, tool type number, magazine number, and pot number. Therefore, it is necessary to newly associate the tool number and the tool offset amount with each other. Thus, in the case where a tool having been being used in a machine tool A is relocated for use in a machine tool B, for example, it is operationally difficult to divert the offset amount of the tool measured in the machine tool A to use in the machine tool B.

### SUMMARY OF THE INVENTION

The present invention has been made to solve these problems and has an object to provide a tool management system, tool management device, and tool management method for performing efficient tool management.

A tool management system according to an embodiment of the present invention includes a tool management device configured to manage information on a tool used by a machine tool which performs machining according to a program and a numerical controller for controlling the machine tool. The numerical controller includes a tool attachment detection unit configured to notify the tool management device of information on a mounted state of the tool in the machine tool. And the tool management device includes a tool management data storage unit configured to store tool management data in which tool type data including information common to tool types and tool object data including information on each individual tool are associated with one another. The tool object data includes the information on the mounted state of the tool.

The tool type data may be capable of uniquely identified by a tool type name, the tool object data may he capable of uniquely identified by a tool name, the program may specify a use tool by the tool type name, and the numerical controller may further comprise a tool selection unit configured to select the tool mounted in the machine tool with reference to the tool management data, based on the tool type name described in the program.

The tool management system may further comprise a CAM for creating the program and the CAM can comprise a program creation unit for creating the program by using the tool type name.

The tool attachment detection unit may identify the tool name of the tool and a magazine and a pot in which the tool is mounted when the tool is mounted in the machine tool and notify the tool management device of the identified information as the information on the mounted state of the tool.

The tool attachment detection unit may further notify the tool management device of information on the life or offset of the tool as the information on the mounted state of the tool.

A tool management device according to an embodiment of the present invention is configured to manage information on a tool used by a machine tool which performs machining according to a program. The tool management device includes a tool management data storage unit that is configured to store tool management data in which tool type data including information common to tool types and tool object data including information on each individual tool are associated with one another, and a tool object data generation unit that is configured to receive information on a mounted state of the tool in the machine tool. The tool object data includes the information on the mounted state of the tool.

A tool management method according to an embodiment of the present invention is a method in which a tool management device manages information on a tool used by a machine tool which performs machining according to a program. The tool management method includes a step of receiving information on a mounted state of the tool in the machine tool, a step of generating tool object data including the information on the mounted state of the tool, and a step of storing tool management data in which tool type data including information common to tool types and the tool object data including information on each individual cool are associated with one another.

According to the present invention, there can be provided a tool management system, tool management device, and tool management method for performing efficient tool management.

### BRIEF DESCRIPTION OF THE DRAWINGS

FIG. 1 is a diagram showing a conventional tool management method;

FIG. 2 is a diagram showing a hardware configuration example of a tool management system;

FIG. 3 is a diagram showing a hardware configuration example of a tool management device;

FIG. 4 is a diagram showing a hardware configuration example of a CAM;

FIG. 5 is a diagram showing a hardware configuration example of a CNC;

FIG. 6 is a diagram showing a functional configuration example of the tool management system;

FIG. 7 is a diagram showing an operation example of the tool management system;

FIG. 8 is a diagram showing an operation example of the tool management system;

FIG. 9 is a diagram showing an operation example of the tool management system;

FIG. 10 is a diagram showing an operation example of the tool management system;

FIG. 11 is a diagram showing an operation example of the tool management system;

FIG. 12 is a diagram showing an operation example of the tool management system; and

FIG. 13 is a diagram showing a modification of the tool management system.

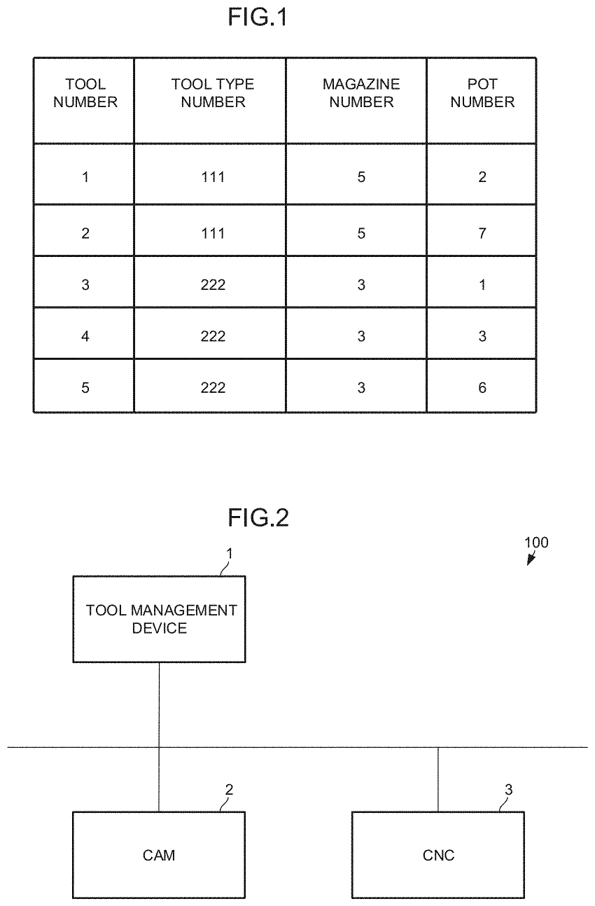

### DETAILED DESCRIPTION OF THE PREFERRED EMBODIMENTS

FIG. 2 is a schematic hardware configuration diagram of a tool management system 100.

The tool management system 100 comprises a tool management device 1, CAM 2, and CNC 3. The tool management device 1, CAM 2, and CNC 3 are connected to one another for wired or wireless communication.

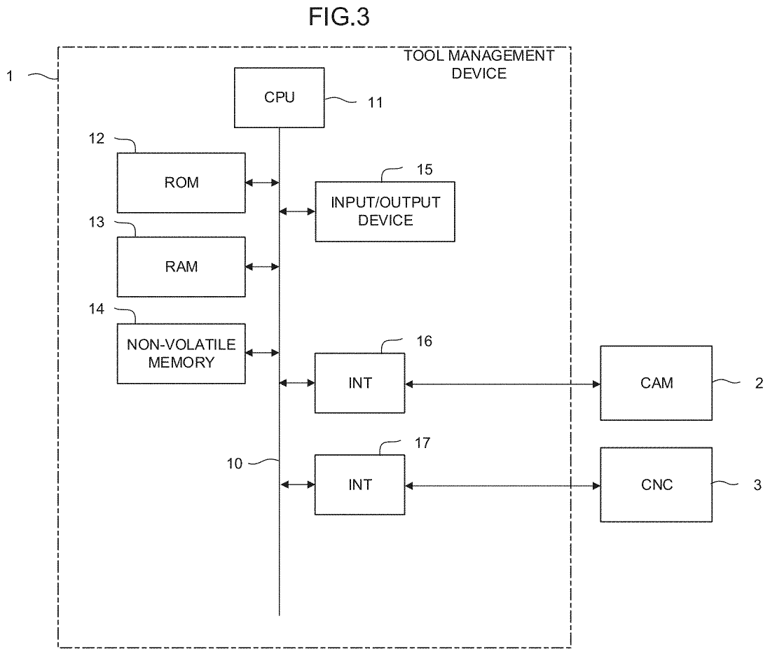

FIG. 3 is a schematic hardware configuration diagram of the tool management device 1.

The tool management device 1 is an information processing device for controlling tool information and is, for example, a PC (personal computer). The tool management device 1 comprises a CPU 11, ROM 12, RAM 13, non-volatile memory 14, input/output device 15, interface 16, interface 17, and bus 10.

The CPU 11 is a processor for generally controlling the tool management device 1. Typically, the CPU 11 reads out a system program stored in the ROM 12 via the bus 10 and controls the entire tool management device 1 according to the system program.

The ROM 12 is previously loaded with system programs. The RAM 13 is temporarily loaded with temporary calculation data and display data, data input and output through the input/output device 15 (described later) and the interfaces 16 and 17, and the like. The non-volatile memory 14 maintains its storage state even after the tool management device 1 is switched off. For example, the non-volatile memory 14 stores tool management programs, tool management data, and the like. The programs and data stored in the non-volatile memory 14 may be developed in the. RAM 13 during execution and use.

The input/output device 15 is a data input/output device comprising a display device such as a display and an input device such as a keyboard. For example, the input/output device 15 displays information received from the CPU 11 on he display. Moreover, it delivers the data input through the keyboard to the CPU 11.

The interface 16 is an interface for communication with the CAM 2 by a wired or wireless communication means. Data output by the CPU 11 is delivered to the CAM 2 through the interface 16. Data output by the CAM 2 is delivered to the CPU 11 through the interface 16.

The interface 17 is an interface for communication with the CNC 3 by a wired or wireless communication means. Data output by the CPU 11 is delivered to the CNC 3 through the interface 17. Data output by the CNC 3 is delivered to the CPU 11 through the interface 17.

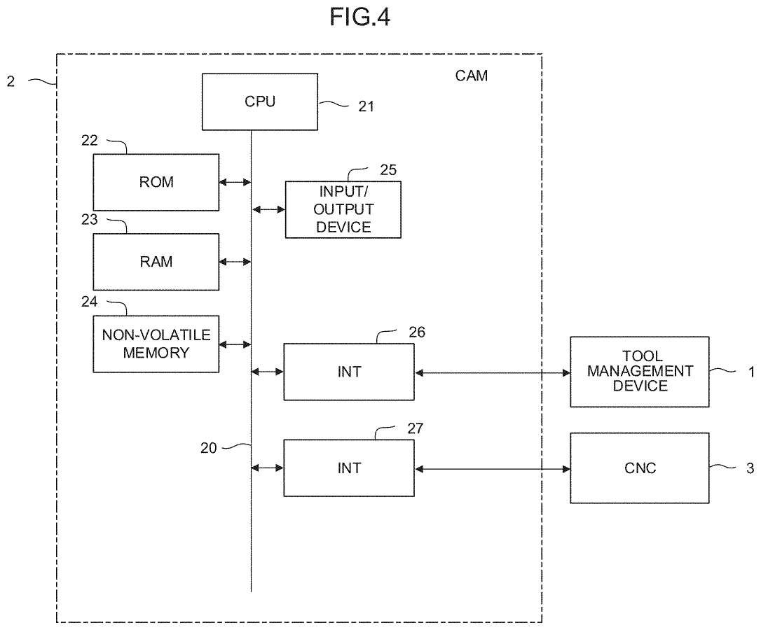

FIG. 4 is a schematic hardware configuration diagram of the CAM 2.

The CAM 2 is an information processing device that generates and outputs an NC program for machining a workpiece and is, for example, a PC (personal computer). The CAM 2 comprises a CPU 21, ROM 22, RAM 23, non volatile memory 24, input/output device 25, interface 26, interface 27, and bus 20.

The CPU 21 is a processor for generally controlling the CAM. 2. Typically, the CPU 21 reads out a system program stored in the ROM 22 via the bus 20 and controls the entire CAM 2 according to the system program.

The ROM 22 is previously loaded with system programs. The RAM 23 is temporarily loaded with temporary calculation data and display data, data input and output through the input/output device 25 (described later) and the interfaces 26 and 27, and the like. The non-volatile memory 24 maintains its storage state even after the CAM 2 is switched off. For example, the non-volatile memory 24 stores NC program creation programs, tool data, and the like. The programs and data stored in the non-volatile memory 24 may be developed in the RAM 23 during execution and use.

The input/output device 25 is a data input/output device comprising a display device such as a display and an input device such as a keyboard. For example, the input/output device 25 displays information received from the CPU 21 on the display. Moreover, it delivers the data input through the keyboard to the CPU 21.

The interface 26 is an interface for communication with the tool management device 1 by a wired or wireless communication means. Data output by the CPU 21 is delivered to the tool management device 1 through the interface 26. Data output by the tool management device 1 is delivered to the CPU 21 through the interface 26.

The interface 27 is an interface for communication with the CNC 3 by a wired or wireless communication means. Data output by the CPU 21 is delivered to the CNC 3 through the interface 27. Data output by the CNC 3 is delivered to the CPU 21 through the interface 27.

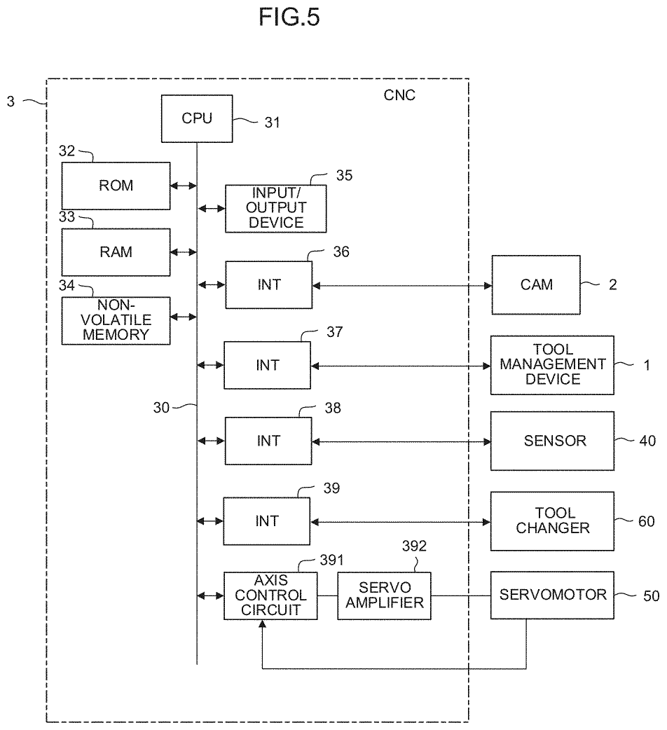

FIG. 5 is a schematic hardware configuration diagram of the CNC 3.

The CNC 3 is a numerical controller configured to control a machine tool according to the NC program. The CNC 3 comprises a CPU 31, ROM 32, RAM 33, non-volatile memory 34, input/output device 35, interfaces 36, 37, 38 and 39, axis control circuit 391, servo amplifier 392, and bus 30.

The CPU 31 is a processor for generally controlling the CNC 3. Typically, the CPU 31 reads out a system program stored in the ROM 32 via the bus 30 and controls the entire CNC 3 according to the system program.

The ROM 32 is previously loaded with system programs. The RAM 33 is temporarily loaded with temporary calculation data and display data, data input and output through the input/output device 35 (described later) and the interfaces 36, 37, 38 and 39, and the like. The non-volatile memory 34 maintains its storage state even after the CNC 3 is switched off. For example, the non-volatile memory 34 stores NC programs, various data, and the like. The programs and data stored in the non-volatile memory 34 may be developed in the RAM 33 during execution and use.

The input/output device 35 is a data input/output device comprising a display device such as a display and an input device such as a keyboard. For example, the input/output device 35 displays information received from the CPU 31 on the display. Moreover, it delivers the data input through the keyboard to the CPU 31.

The interface 36 is an interface for communication with the CAM 2 by a wired or wireless communication means. Data output by the CPU 31 is delivered to the CAM 2 through the interface 36. Data output by the CAM 2 is delivered to the CPU 31 through the interface 36.

The interface 37 is an interface for communication with the tool management device 1 by a wired or wireless communication means. Data output by the CPU 31 is delivered to the tool management device 1 through the interface 37. Data output by the tool management device 1 is delivered to the CPU 31 through the interface 37.

A sensor 40 is connected to the interface 38. The sensor 40 is a sensor configured to identify the number of a magazine mounted with a tool, a pot number, and the tool name of the mounted tool. For example, the sensor 40 is an image sensor configured to acquire a magazine number, pot number, and tool name encoded into two-dimensional codes and previously affixed to the tool, magazine, and pot. The present invention is not limited to this and may also be configured to acquire any information by which the tool, magazine, and pot can be uniquely identified. The sensor 40 delivers the acquired magazine number, pot number, and tool name in a set to the CPU 31 through the interface 38.

A tool changer 60 is connected to the interface 39. The tool changer 60 comprises one or more magazines, each magazine comprises one or more pots, and each pot is mounted with a tool. The CPU 31 gives commands for the magazine number and the pot number to the tool changer 60 through the interface 39. The tool changer 60 selects the magazine and the pot according to the commands and prepares for use of the tool mounted in the selected pot.

The axis control circuit 391 controls the motion axes of the machine tool. The axis control circuit 391 receives an axis movement amount output by the CPU 31 and outputs a movement command for each motion axis to the servo amplifier 392.

On receiving the axis movement command output by the axis control circuit 391, the servo amplifier 392 drives the servomotor 50. The servomotor 50 is driven by the servo amplifier 392 to move the motion axes of the machine tool. The servomotor 50 typically has a position/speed detector built-in. The position/speed detector outputs a position/speed feedback signal, and position/speed feedback control is performed as this signal is fed back to the CPU 31.

In FIG. 5, the axis control circuit 391, servo amplifier 392, and servomotor 50 are each shown as being only one in number. Actually, however, these elements are provided corresponding in number to the axes of the machine tool to be controlled.

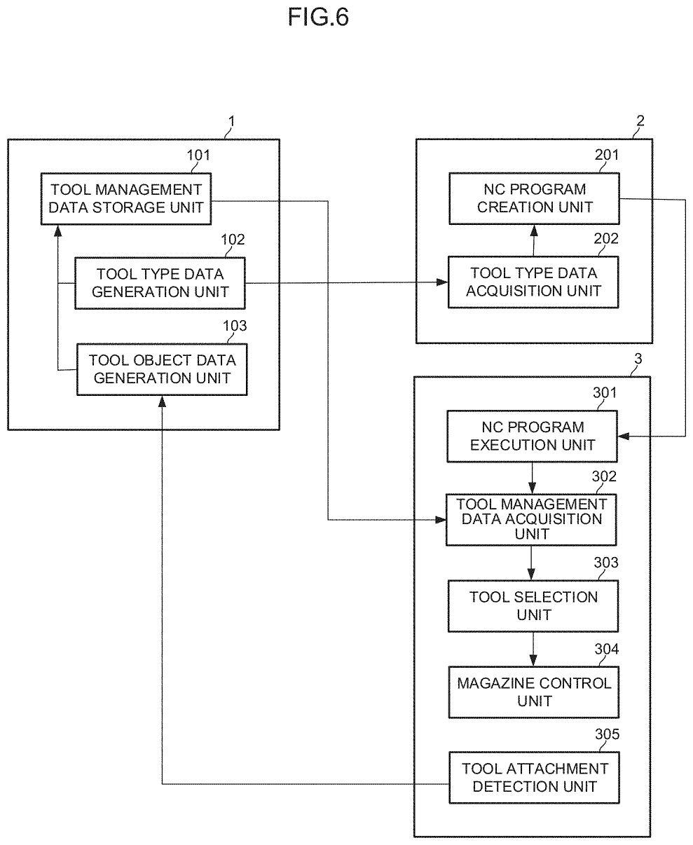

FIG. 6 is a block diagram showing a schematic functional configuration of the tool management system 100.

The tool management system 100 comprises the tool management device 1, CAM 2, and CNC 3. The tool management device 1 comprises a tool management data storage unit 101, tool type data generation unit 102, and tool object data generation unit 103. The tool management data storage unit 101 is a storage area (database) that stores the tool management data composed of tool type data and tool object data.

The tool type data is a set of pieces of attribute information common to a plurality of tools. For example, the tool type data includes a unique tool type name and catalog data associated therewith. The catalog data includes a tool manufacturer name, model number, dimensions, cutting conditions, images, and the like. In this case, the tool type name functions as a label for the attribute information common to all the tools (or tool types) belonging to a certain model number of the manufacturer.

The tool object data is a set of pieces of attribute information of each individual tool. For example, the tool object data includes a unique tool name and a tool type name associated therewith, machine tool name, magazine number, pot number, tool life, and offset data. In this case, the tool name functions as a label for reference to the tool type name of the tool, the way the tool is mounted in the machine tool, the values of the tool life and the offset data, and the like.

Normally, one and the same tool type name can be given to a plurality of tool object data. This is because there can be a plurality of tools of the same model number and the same tool manufacturer. Therefore, the tool type data and the tool object data are linked in a one-to-many relationship. In other words, each individual tool object is an instance that takes over attributes defined as the tool type data. A plurality of such tool objects (as many as tool entities) can be produced.

Preferably, the tool management data storage unit 101 should be located in an externally accessible storage area, such as a storage or external memory with the tool management data released on network. If this is done, the CAM 2 and the CNC 3 can access the tool management data. Moreover, an analysis device (not shown) can be caused to access information such as the tool life aggregated into the tool management data and serve for strategic planning for optimization of tool use.

The tool type data generation unit 102 generates the aforesaid tool type data. Typically, the tool type data generation unit 102 acquires the tool catalog data provided by a tool manufacturer or the like with reference to a predetermined storage area (e.g., a web server or cloud storage), through a communication network or the like. The tool type data generation unit 102 assigns unique tool type names to model numbers included in the manufacturer's catalog data in a one-to-one relationship. Typically, the manufacturer name and model number can be incorporated in the tool type name. If the tool type name is assigned in this manner, the manufacturer name and the model number may be excluded after the tool type name is given.

The tool object data generation unit 103 generates the aforesaid tool object data. Typically, the tool object data generation unit 103 communicates with the CNC 3 through the interface 17 and acquires the tool name, tool type name, machine tool name, magazine number, pot number, tool life, and offset data for each of the tools attached to the pots. An example of a method for acquiring the number of the magazine mounted with the tool and the pot number will be explained later. Since the machine tool name, tool life, and offset data can be acquired by using a standard function of the CNC 3, a detailed description thereof is omitted herein. It is assumed that a unique tool name is assigned to each tool.

The CAM 2 comprises an NC program creation unit 201 and a tool type data acquisition unit 202. Typically, the NC program creation unit 201 creates an NC program based on CAD data. Since the operation of the NC program creation unit 201 is a conventional technique, a detailed description thereof will be omitted.

The tool type data acquisition unit 202 communicates with the tool management device 1 through the interface 26, acquires the tool type data from the tool management data storage unit 101, and accumulates the acquired data in a storage area (not shown). The NC program creation unit 201 refers to the tool type data acquired and accumulated by the tool type data acquisition unit 202 and creates the NC program using the tool type name defined in the tool management data storage unit 101. Specifically, in the NC program created by the NC program creation unit 201, a use tool is specified by the tool type name described in the tool management data storage unit 101.

The CNC 3 comprises an NC program execution unit 301, tool management data acquisition unit 302, tool selection unit 303, magazine control unit 304, and tool attachment detection unit 305.

The NC program execution unit 301 interprets and executes the NC program created by the NC program creation unit 201. Since the operation of the NC program execution unit 301 is well-known, a detailed description thereof is omitted herein. If the tool type name is described in the NC program, the NC program execution unit 301 delivers it to the tool selection unit 303.

The tool management data acquisition unit 302 communicates with the tool management device 1 through the interface 37, acquires the tool management data from the tool management data storage unit 101, and accumulates the acquired data in a storage area (not shown).

The tool selection unit 303 refers to the tool management data acquired and accumulated by the tool management data acquisition unit 302 and converts the tool type name used in the NC program to a specific tool name, thereby identifying the tool name to be used for machining. The following is a more specific description of processing by the tool selection unit 303 for identifying the tool name to be used for the machining.

The tool selection unit 303 first extracts only those records which, among the tool management data acquired and accumulated by the tool management data acquisition unit 302, include the name of the machine tool to be controlled. Then, if the tool type name is described in the NC program, the tool selection unit 303 searches for the tool name associated with the tool type name in the tool management data. If a single tool name is found, it is the name of the tool to be used for the machining. The tool selection unit 303 delivers the magazine number and the pot number in the tool management data associated with the tool name to the magazine control unit 304. If a plurality of tool names are found, in contrast, the tool selection unit 303 is expected to select one of the records including the tool name concerned based on an arbitrary condition and use the selected tool for the machining. The tool selection unit 303 can select, for example, a cool with the shortest (or least) tool life (remaining life).

The magazine control unit 304 commands the tool changer 60 through the interface 39 to select the magazine number and the pot number delivered from the tool selection unit 303. In this way, the tool identified by the tool selection unit 303 is made usable.

The tool attachment detection unit 305 is activated when the tool is mounted in the pot. Let us assume that, as a preparation, a two-dimensional code obtained by encoding the tool name and the tool type name, two-dimensional code obtained by encoding the magazine number, and two-dimensional code obtained by encoding the pot number, for example, are affixed to each tool, magazine, and pot, respectively. When the tool attachment detection unit 305 detects that the tool is mounted in position, it reads the two-dimensional codes affixed to the tool and the magazine and the pot mounted with the tool by means of the image sensor or the sensor 40. The tool attachment detection unit 305 obtains the tool name, tool type name, magazine number, and pot number by decoding he read two-dimensional codes.

The tool attachment detection unit 305 transmits the obtained pieces of information in a set to the tool object data generation unit 103. Using the information received from the tool attachment detection unit 305, the tool object data generation unit 103 adds or updates the records of the tool object data. Specifically, if the tool name included in the received information already exists in the tool object data, the contents of the records are overwritten by the received information. If the tool name included in the received information is not in the tool object data, a record including the received information as its content is added.

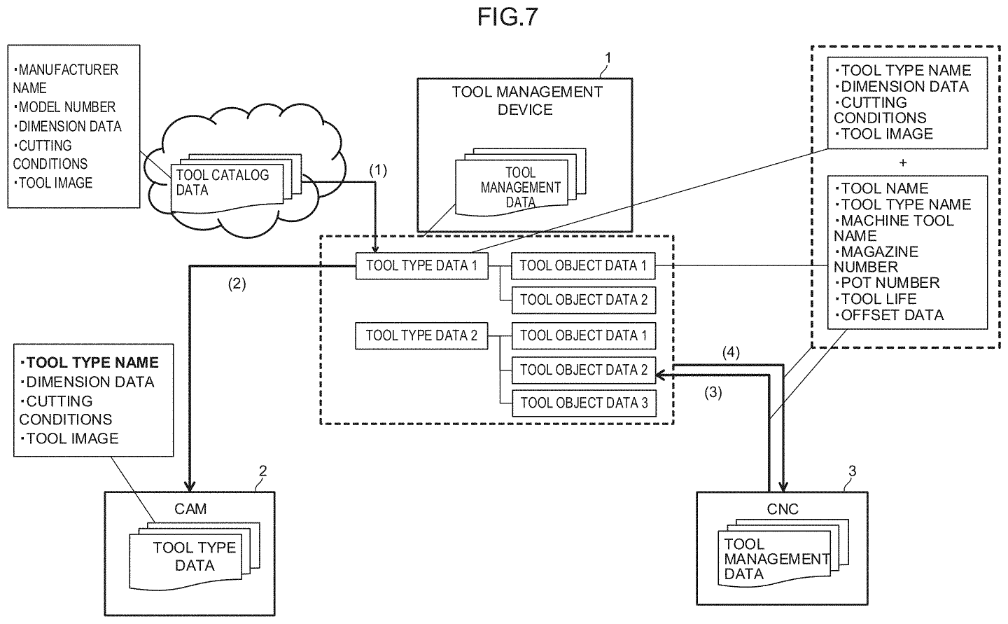

Operation examples of the tool management system 100 will be described further in detail with references to FIGS. 7 to 13.

<Tool Information>

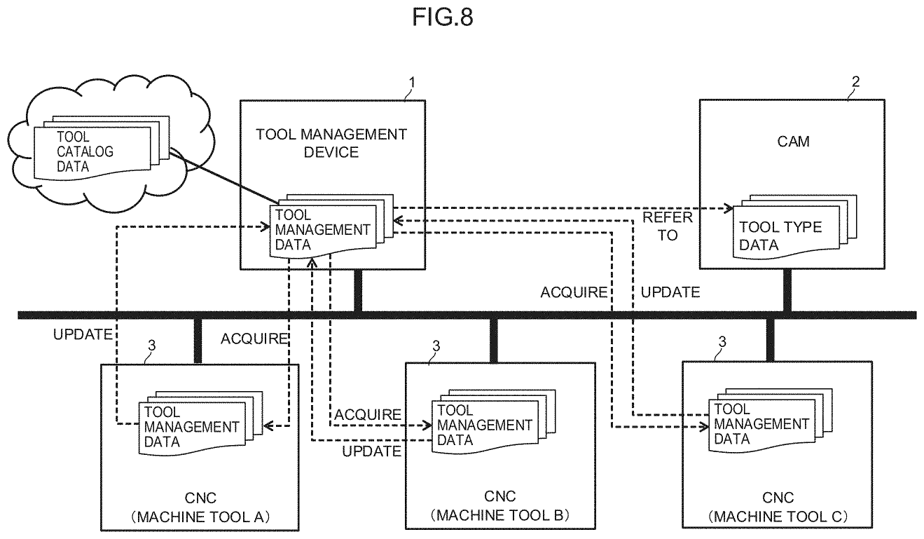

FIGS. 7 and 8 are diagrams showing generation, update, and acquisition flows for the cool management data (including the tool type data and the tool object data).

In (1) of FIG. 7, the tool management device 1 generates the tool type data based on the tool catalog data. Normally, the generated tool type data are as many as tool types (manufacturer's names and model numbers). The CAM 2 acquires the tool type data in (2). The tool type data is used in creating the NC program. In (3), information on the tool mounted in the CNC 3 is transmitted to the tool management device 1, and the tool management device 1 generates the tool object data based on the transmitted information. Hereupon, the tool type data and the tool object data are associated with each other to complete the tool management data. The CNC 3 acquires the tool management data in (4). The tool management data is used in executing the NC program.

FIG. 8 is a diagram showing generation, update, and acquisition flows for the tool management data with a plurality of CNCs 3.

Also with use of the plurality of CNCs 3, the tool management data can be generated, updated, and acquired in the flows similar to those shown in FIG. 7. However, it is necessary only that the CNCs 3 transmit only information on tools mounted in those machine tools controlled by themselves to the tool management device 1 and acquire only the tool management data related to the machine tools controlled by themselves.

<Tool Change>

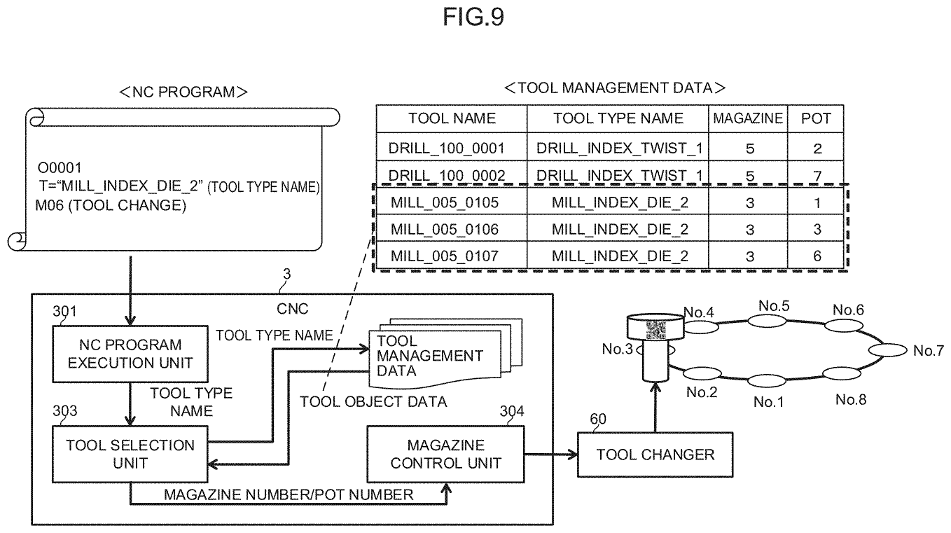

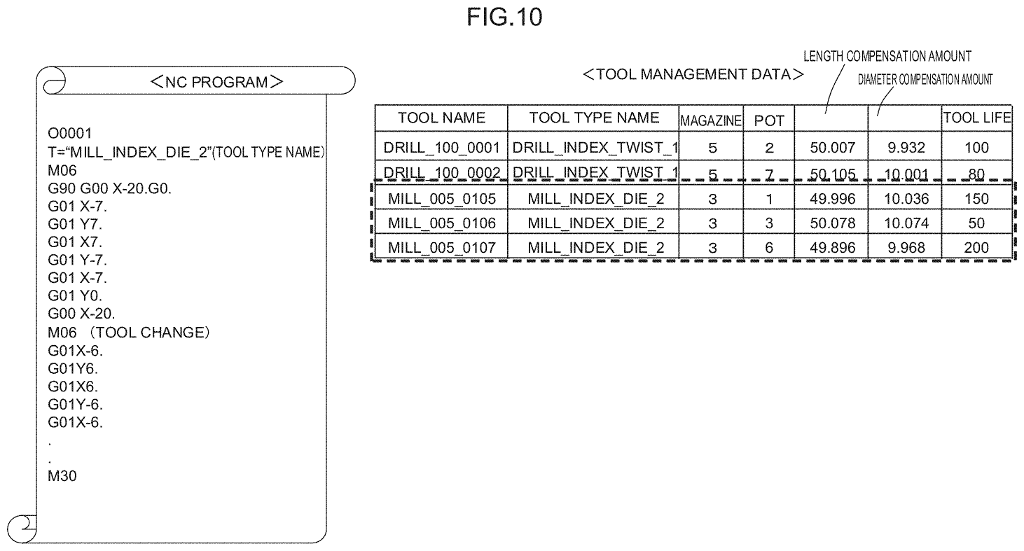

FIGS. 9 and 10 are diagrams showing the operation of the CNC 3 when the tool is changed in response to a command from the NC program.

In FIG. 9, a tool change command for a tool type name “MILL_INDEX_DIE_2” is described in the NC program. The NC program execution unit 301 delivers this tool type name to the tool selection unit 303. The tool selection unit 303 searches for the tool management data using the tool type name as a key and obtains the tool object data corresponding thereto. If there are a plurality of corresponding tool object data, the tool selection unit 303 selects a single tool object data according to a predetermined criterion, such as the shortest tool life, the pot number nearest from the current position, or the like.

The tool selection unit 303 extracts the magazine number and the pot number from the tool object data and delivers them to the magazine control unit. 301. The magazine control unit 304 outputs a command to the tool changer 60 and replaces the tool currently being used with the tool corresponding to the extracted magazine and pot numbers.

FIG. 10 is a diagram showing an operation performed when the tool selection unit 303 selects the tool object data with the shortest tool life.

The tool management data shown in FIG. 10 includes three tool object data corresponding to the tool type name “MILL_INDEX_DIE_2” specified by the NC program. The tool selection unit 303 selects a tool “MILL_005_0106” having the shortest tool life among the three as the use tool in response to a first tool change command M06.

Then, let us assume that the remaining life of the tool with the name “MILL_005_0106” is reduced to zero in the subsequent step of machining. In this case, the tool selection unit 303 should preferably exclude the tool “MILL_005_0106” of which the tool life has expired from the object of selection and select the use tool from the two remaining ones, in response to a second tool change command M06. Specifically, a tool “MILL_005_0105” with a shorter tool life, out of the two remaining ones, is selected as the use tool. If the tool life of the tool “MILL_005_0106” has not expired, the tool selection unit 303 can continue to use it without exchanging the tool in response to the second tool change command M06.

### <Sharing of Tool Management Data>

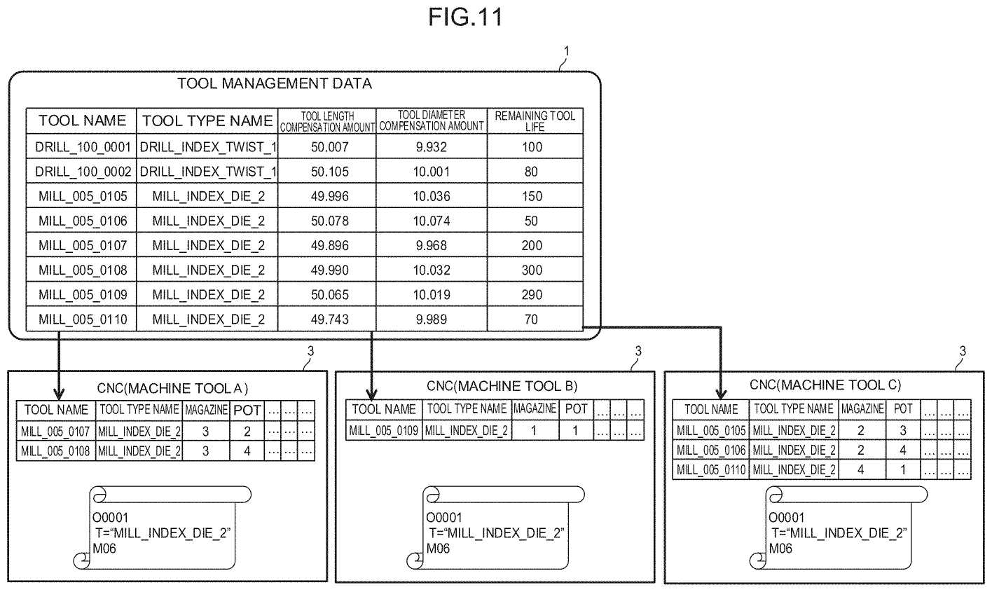

FIG. 11 is a diagram showing the operation of a plurality of CNCs 3 that use common tool management data.

In the example of FIG. 11, three CNCs 3 connected individually to machine tools A, B, and C refer to the common tool management data. Each CNC 3 extracts only the tool management data related to the machine tool controlled by itself from the common tool management data and holds the extracted data in a local area.

Now let us assume that the three CNCs 3 connected individually to the machine tools A, B, and C execute the same NC program. The NC program includes a tool change command for the tool type name “MILL_INDEX_DIE_2”. The tool selection unit 303 of each CNC 3 searches for the tool management data in the local area using the tool type name as the key and obtains the corresponding tool object data. Since the tool management data held by the CNCs 3 have different contents, the tool object data to be retrieved can also be different. Therefore, in the CNC 3 for controlling the machine tool A, for example, tool exchange is performed for either a tool name “MILL_005_0107” or “MILL_005_0108”. In the CNC 3 for controlling the machine tool B, the tool exchange is performed for a tool name “MILL_005_0109”. Moreover, in the CNC 3 for controlling the machine tool C, the tool exchange is performed for a tool name “MILL_005_0109”. Moreover, in the CNC 3 for controlling the machine tool C, the tool exchange is performed for the tool name “MILL_005_0105” or “MILL_005_0106” or a tool name “MILL_005_0110”. Thus, according to the present invention, an appropriate tool can be selected depending on the mounted state of the tool for each machine tool by using the common NC program.

<Registration of Tool Object Data>

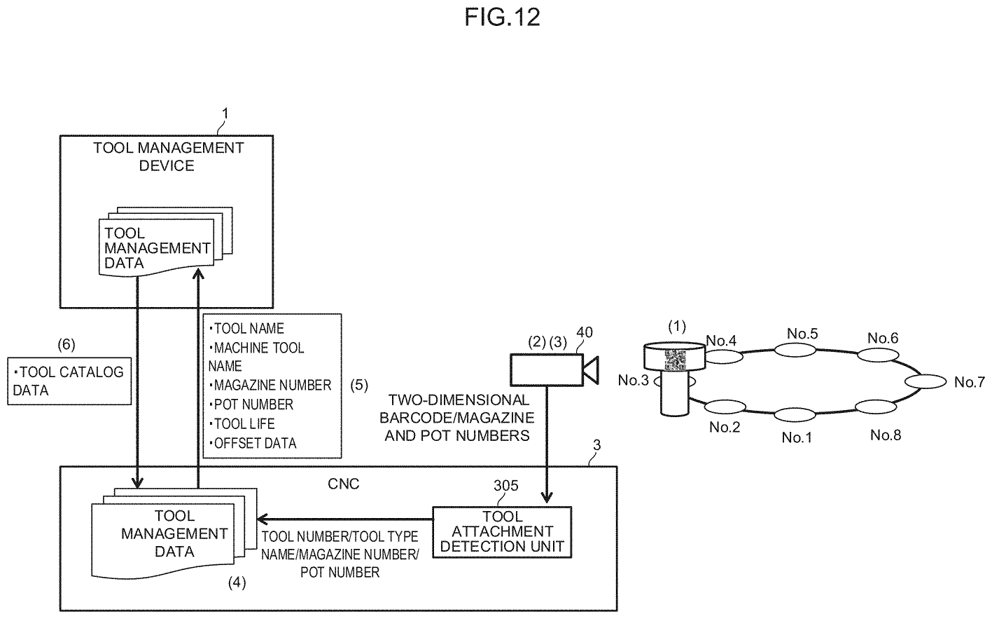

FIG. 12 is a diagram showing a processing flow in which tool object data related to tools mounted in a machine tool is automatically registered in the tool management data.

A tool is mounted in a pot in (1) of FIG. 12. The tool attachment detection unit 305 reads out the tool name and the tool type name of the mounted tool in (3). In (3), the tool attachment detection unit 305 reads out the magazine and pot numbers, respectively, of the magazine and the pot in which the tool is mounted. In (4), the tool attachment detection unit 305 temporarily loads the tool name, tool type name, magazine number, and pot number, in a set, into a storage area (not shown). Moreover, the tool attachment detection unit 305 acquires and temporarily stores the machine tool name, tool life, and offset data using the standard function of the CNC 3. In (5), the tool attachment detection unit 305 transmits these data in a set to the tool object data generation unit 103. The tool object data generation unit 103 adds new tool object data containing the received data into the tool management data or updates the contents of existing tool object data with he received data. The tool management data acquisition unit 302 receives the updated tool management data in (6).

Thereupon, the tool management data storage unit 101 holds the tool life and the offset data transmitted to the tool management device 1 in (4) of FIG. 12, as tool management data that can also be referred to by the other CNCs 3. Thus, if the tool is relocated in a new CNC 3 thereafter, the values of the tool life, offset data, and the like having been used in the previous CNC 3 can be diverted to use in the new CNC 3.

If the tool name, cool type name, magazine number, pot number, machine tool name, tool life, and offset data are temporarily locally stored in (4) of FIG. 12, then information equivalent to the added or updated tool object data is already locally held. Thus, the tool management data acquisition unit 302 may be configured to locally update the tool management data by acquiring, from the tool management device 1, tool type data (typically including information equivalent to the catalog data) corresponding to temporarily stored cool object data and only those pieces of information in the tool object data which are not locally held and combining acquired difference data with the temporarily stored information.

### Other Embodiments

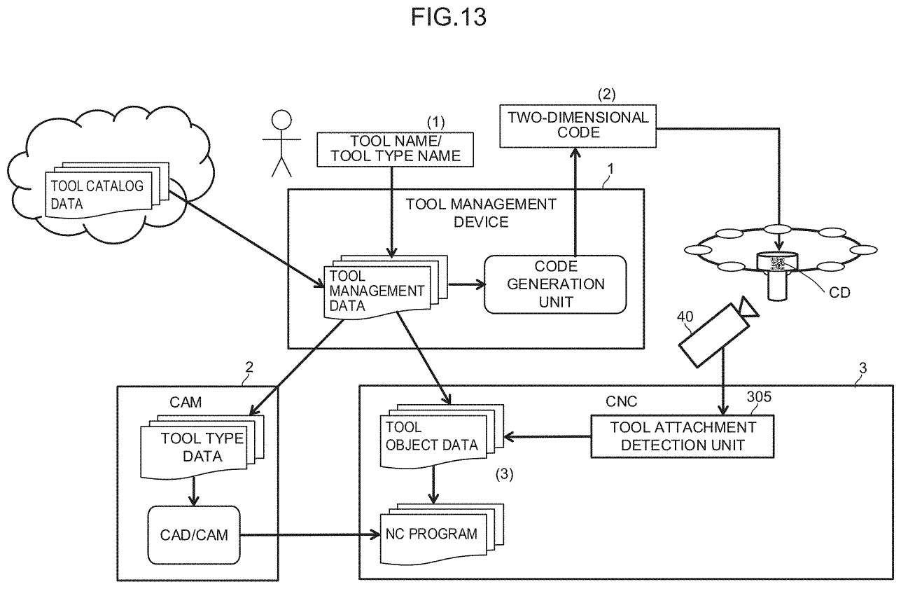

FIG. 13 is a diagram showing various embodiments of the tool management system 100.

In the above-described embodiment, the sensor 40 is illustrated as being configured to read the tool name and the tool type name that are encoded into the two-dimensional codes affixed to the tool. However, the present invention is not limited to this and the correspondence between the tool name and the tool type name may be given by an alternative method. As shown in (1) of FIG. 13, for example, the correspondence. between the tool name and the tool type name may be input to the tool management device 1 by a user. In this case, it is necessary only that only the tool name be encoded into the two-dimensional code CD affixed to the tool.

Moreover, as shown in (2) of FIG. 13, the tool management device 1 may further comprise a code generation unit configured to output two-dimensional codes to be affixed to the tool, magazine, and pot in the form of a seal. Thus, the present invention can be carried out more accurately and efficiently.

In the above-described embodiment, the tool management data acquisition unit 302 of the CNC 3 is illustrated as being configured to locally hold the tool management data. However, the present invention is not limited to this and the tool management data acquisition unit 302 may also be configured at least to locally hold only the cool object data. If the tool object data is locally held, the tool selection unit 303 can select an appropriate tool. On the other hand, if the tool management data including the tool type data is locally held, the catalog data can be referred to on the CNC 3, for example, so that the work efficiency can be improved.

According to the present embodiment, each individual tool can be identified by a unique tool name independent of the setting and the like of the machine tool. In the NC program, moreover, the tool can be identified by the tool type name, not the tool name, so that a general-purpose program independent of a specific tool or machine tool can be provided. Thus, the same NC program can be used without requiring editing in a plurality of machine tools that employ tools of the same type.

Moreover, according to the present embodiment, each individual tool can be managed with a unique tool name, and the tool name and information (tool life, tool offset, etc.) peculiar to the tool can be held in a one to one relationship, and further these pieces of information can be shared with another machine tool. Therefore, the information peculiar to the tool can be shared in common by a plurality of machine tools, so that operations for tool registration that used to be performed for each machine tool can be reduced.

Furthermore, according to the present embodiment, the image sensor or the like reads the tool name, tool type name, magazine number, and pot number and the tool object data is registered when the tool is installed. Thus, most of the operations for tool registration that have been performed manually can be automated.

While the principal embodiment of the present invention has been described herein, the invention is not limited to the above embodiment and may be suitably modified and embodied in various forms. For example, the tool management device 1 is described as being a device separate from the CAM 2 or the CNC 3 in the above embodiment. However, the invention is not limited to this and the tool management device 1 may be constructed as a function of the CAM 2 or the CNC 3. Alternatively, the tool management device 1 may be virtually implemented by a technique such as the so-called cloud computing.

1. A tool management system comprising a tool management device configured to manage information on a tool used by a machine tool which performs machining according to a program and a numerical controller for controlling the machine tool, wherein
the numerical controller comprises a tool attachment detection unit configured to notify the tool management device of information on a mounted state of the tool in the machine tool, and
the tool management device comprises a tool management data storage unit configured to store tool management data in which tool type data including information common to tool types and tool object data including information on each individual tool are associated with one another, and wherein
the tool object data includes the information on the mounted state of the tool.

2. The tool management system according to claim 1, wherein
the tool type data is capable of being uniquely identified by a tool type name,
the tool object data is capable of uniquely identified by a tool name,
the program specifies a use tool by the tool type name, and
the numerical controller further comprises a tool selection unit configured to select the tool mounted in the machine tool with reference to the tool management data, based on the tool type name described in the program.

3. The tool management system according to claim 2, further comprising a CAM for creating the program, wherein
the CAM comprises a program creation unit for creating the program by using the tool type name.

4. The tool management system according to claim 2, wherein the tool attachment detection unit identifies the tool name of the tool and a magazine and a pot in which the tool is mounted when the tool is mounted in the machine tool and notifies the tool management device of the identified information as the information on the mounted state of the tool.

5. The tool management system according to claim 4, wherein the tool attachment detection unit further notifies the tool management device of information on the life or offset of the tool as the information on the mounted state of the tool.

6. A tool management device configured to manage information on a tool used by a machine tool which performs machining according to a program, the tool management device comprising:
a tool management data storage unit configured to store tool management data in which tool type data including information common to tool types and tool object data including information on each individual tool are associated with one another; and
a tool object data generation unit configured to receive information on a mounted state of the tool in the machine tool, wherein
the tool object data includes the information on the mounted state of the tool.

7. A tool management method in which a tool management device manages information on a tool used by a machine tool which performs machining according to a program, the tool management method comprising:
a step of receiving information on a mounted state of the tool in the machine tool,
a step of generating tool object data including the information on the mounted state of the tool; and
a step of storing tool management data in which tool type data including information common to tool types and the tool object data including information on each individual tool are associated with one another.
